(19) United States
(12) Patent Application Publication
(10) Pub. No.: US 2008/0168528 A1
(43) Pub. Date: Jul. 10, 2008

(54) ROLE-BASED AUTHORIZATION USING CONDITIONAL PERMISSIONS

(76) Inventors: Dah-Haur Lin, Austin, TX (US); Satoshi Hada, Yokohama-shi (JP); Anthony Joseph Nadalin, Austin, TX (US); Nataraj Nagaratnam, Morrisville, NC (US)

Correspondence Address: IBM CORP. (DHJ);c/o DAVID H. JUDSON, 15950 DALLAS PARKWAY, SUITE 225, DALLAS, TX, 75248, US

(21) Appl. No.: 11/619,672

(22) Filed: Jan. 4, 2007

(51) Int. Cl. G06F 21/00

(52) U.S. Cl. 726/1

(57) ABSTRACT

The present invention implements a set of interfaces for a standard Java execution environment to provide authorization with conditional permissions. In particular, a framework enables a provider to provide a condition-based runtime authorization decision when a caller entity requests a Java resource. To this end, during a policy configuration certain “Conditions” may be associated with a standard Java Permission object using a ConditionalPermission class. Each “Condition” may be represented in one of a set of different conditions (e.g., containment, logical, comparison, owner and regular expression conditions) using various name-value pairs of “AttributeName” objects. During runtime, an “implies” method in the ConditionalPermission class returns true if the argument permission is implied by the wrapped permission and the additional “Conditions” are evaluated to be true. The ConditionalPermission class allows the caller to seamlessly instrument an instance evaluation “Condition” into a regular permission evaluation and to hand off this evaluation to a provider to facilitate an instance-based runtime authorization decision. The framework is highly flexible and provides for a wide-range of possible fine-grained policy and instance-based “Conditions” for authorization evaluation.

### COPYRIGHT STATEMENT

A portion of the disclosure of this patent document contains material that is subject to copyright protection. The copyright owner has no objection to the facsimile reproduction of the patent document as it appears in the Patent & Trademark Office file or records, but it otherwise reserves all copyright rights.

### BACKGROUND OF THE INVENTION

1. Technical Field

This invention relates generally to methods and systems that facilitate access to shared resources in a distributed computer environment.

2. Background of the Related Art

Enterprises often implement their business services as multi-tier applications. Thus, in a representative example, Web-based technologies may be used as an outer tier to interface users to the application, while a middleware tier comprises business logic that integrates the application with existing enterprise information systems such as back end databases. The Java 2 Platform, Enterprise Edition (J2EE) is a technology and an associated component-based model that reduces the cost and complexity of implementing these multi-tier enterprise services. The J2EE runtime environment provides various application components for use in building such services, namely Web tier components (e.g., servlets, JSP pages, Java beans, and the like), and Enterprise tier components (e.g., session beans, entity beans and the like). Web tier components typically execute in a web server and respond to HTTP request from web clients, while Enterprise tier components typically execute in an application server and include business logic to support transactions. Runtime support for J2EE application components are provided by containers, which execute the application components and provide other services. J2EE-compliant platforms, such as IBM® WebSphere® application server, are well-known.

For application security, J2EE provides for security services including authentication and authorization. In particular, the J2EE authorization model is used to determine if a caller has the necessary privilege to request a service. It is role based. In particular, and with reference to FIG. 1, the model is based on the concept of a security role 100, which is a logical grouping of users (e.g., managers, tellers, customers) typically defined by an application component developer or assembler. A deployer typically maps a given security role to one or more security identities 102 (e.g., a principal, a group, and the like) in the operational environment. The security roles are mapped to the application components which, as noted above, typically are organized in a Web tier 104 and a separate Enterprise tier 106. Fundamentally, the J2EE role-based authorization model relies on three primary elements to make an authorization decision. These are “principal,” “security role,” and “permission.” A principal is an entity that can be authenticated by an authentication protocol in a security service that is deployed in an enterprise. As noted above, a security role is a logical grouping of users. The permission is a set of activities (a set of one or more operations on some set of one or more resources) that is the target of an authorization decision.

The Java Authorization Contract for Containers (JACC) is a specification introduced in J2EE 1.4. This specification defines a “contract” between J2EE containers and authorization providers. JACC enables any third-party authorization provider to plug into any J2EE 1.4 application server to make authorization decisions when a J2EE resource is being accessed. This framework is illustrated in FIG. 2 for an application server 200 (or, more generally, any J2EE-compliant platform) having a container 202. As can be seen, the contract 204 interfaces the container 202 to a provider repository 208 through a policy object 206, which makes the access decision. The JACC middleware layer allows for separate policy configuration management, and it enables runtime evaluation flexibility. In particular, and as seen in FIG. 3, the JACC layer makes the authorization decision based on two (2) mappings, namely a mapping 300 of principal-to-role configuration data, and a mapping 302 of permission-to-role configuration data. The actual authorization decision is made at a Permission.implies( ) method interface call.

The JACC specification defines new Java security permission classes to satisfy the J2EE authorization model. In particular, the specification defines the binding of container access decisions to operations on instances of these permission classes. The specification also defines the semantics of policy providers that employ the new permission classes to address the authorization requirements of J2EE, including the following: the definition of roles as named collections of permissions, the granting to principals of permissions corresponding to roles, the determination of whether a principal has been granted the permissions of a role, and the definition of an identifier to role mappings that bind application-embedded identifiers to application-scoped role names. Further, the specification defines the installation and configuration of authorization providers for use by containers, and it defines the interfaces that a provider must make available to allow container deployment tools to create and manage permission collections corresponding to roles.

As real world computing environments become more complicated, the requirements for security software becomes greater as well. From a security viewpoint, so-called “fine-grained” access control policy manageability and associated runtime instance-based authorization decisions become more important. Nevertheless, under the J2EE specification, permission objects are immutable once they are created, and subclasses are restricted from providing methods that can change the state of a given permission once it has been created. As a consequence, and despite the flexibility provided by the JACC framework, currently it is not possible to inject “instance data” into the J2EE permission object. Thus, fine-grained access control policy manageability and instance-based runtime authorization decisions cannot be provided under the current Java standard specifications.

There remains a need to provide a flexible and powerful approach to extend the current JACC standard in J2EE to support instance-based runtime authorization evaluation.

### BRIEF SUMMARY OF THE INVENTION

The present invention provides a framework that extends a standard Java environment to provide conditional permissions. The framework enables an authorization provider to provide a granular runtime authorization decision when a caller entity requests access to a Java resource.

In particular, the invention provides for a conditional permission, which is preferably implemented as a Java ConditionalPermission class. During policy configuration, certain “Conditions” may be associated with a standard Java Permission object using the ConditionalPermission class. Each “Condition” may be represented in one of a set of different conditions (e.g., containment, logical, comparison, owner and regular expression conditions) using various name-value pairs of “AttributeName” objects. During runtime, an “implies” method in the ConditionalPermission class returns true if the argument permission is implied by the wrapped permission and the additional “Conditions” are evaluated to be true. The ConditionalPermission class allows a caller to seamlessly instrument a granular evaluation “Condition” into a regular permission evaluation and to hand off this evaluation to a provider to facilitate an instance-based runtime authorization decision. The framework is highly flexible and provides for a wide-range of possible fine-grained policy and instance-based “Conditions” for authorization evaluation. Further, the framework may be implemented without requiring code change to the existing Java Permission classes.

In a representative embodiment, the framework is implemented in a set of interfaces or Java classes. These include the main conditional permission class, a set of condition classes, and an attribute name class. The conditional permission class wraps a Java permission instance to add one or more conditions. This class includes one or more methods that return values corresponding to the wrapped permission. The conditional permission class returns true if the argument permission is implied by the wrapped permission and the additional conditions are evaluated to be true. The condition classes are used to define one or more conditions, which include, for example, attribute containment evaluations, attribute comparisons, logical operations, owner evaluations, business rules, and regular expression matching. The attribute name class is used to specify contextual data necessary to evaluate the permissions, e.g., application instance data. In use, the conditional permission class interface is used to specify one or more conditions, e.g., during a policy configuration phase. This conditional permission is then enforced during runtime when an attempt to access an associated Java-based resource.

The foregoing has outlined some of the more pertinent features of the invention. These features should be construed to be merely illustrative. Many other beneficial results can be attained by applying the disclosed invention in a different manner or by modifying the invention as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts a J2EE role-based authorization model;

FIG. 2 illustrates how a third-party authorization provider plugs into a J2EE 1.4 application server to make authorization decisions when a J2EE resource is being accessed;

FIG. 3 is illustrates the mappings implemented by a JACC layer;

FIG. 4 is a representative enterprise environment in which the present invention is implemented;

FIG. 5 illustrates how a J2EE-compliant application server uses a JACC-compliant provider to make an authorization decision;

FIG. 6 illustrates a J2EE JACC conditional permission operation model of the present invention during a policy configuration phase;

FIG. 7 illustrates the J2EE JACC conditional permission operation model of the present invention during a policy decision and enforcement phase;

FIG. 8 is a portion of a first policy statement configured according to the JACC specification without the conditional permission;

FIG. 9 illustrates how the policy statement of FIG. 8 is evaluated at runtime;

FIG. 10 is a portion of a first policy statement configured according to the present invention to include a conditional permission;

FIG. 11 illustrates how the policy statement of FIG. 11 is evaluated at runtime;

FIG. 12 is a portion of a second policy statement configured according to the JACC specification without the conditional permission;

FIG. 13 illustrates how the policy statement of FIG. 12 is evaluated at runtime;

FIG. 14 is a portion of a second policy statement configured according to the present invention to include a conditional permission;

FIG. 15 illustrates how the policy statement of FIG. 14 is evaluated at runtime; and

FIG. 16 illustrates a data processing system for providing the J2EE-compliant platform, or the JACC-compliant provider.

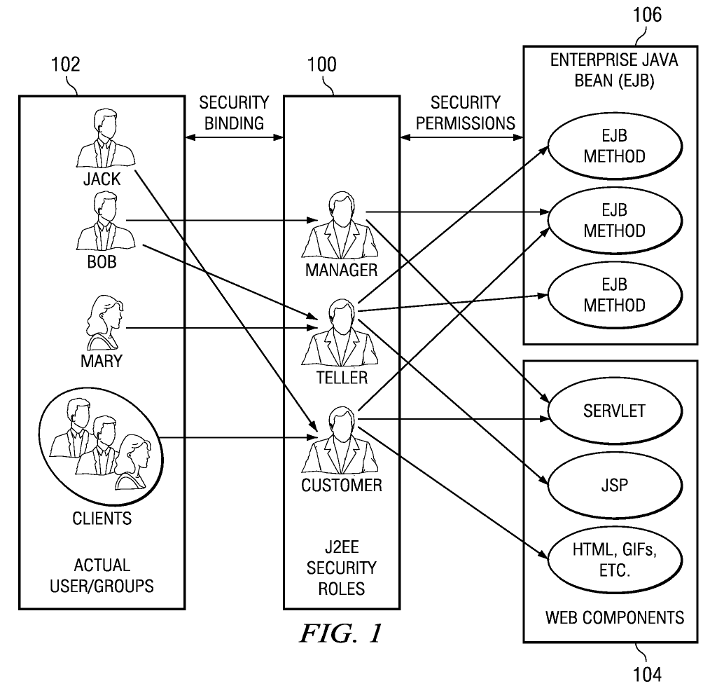

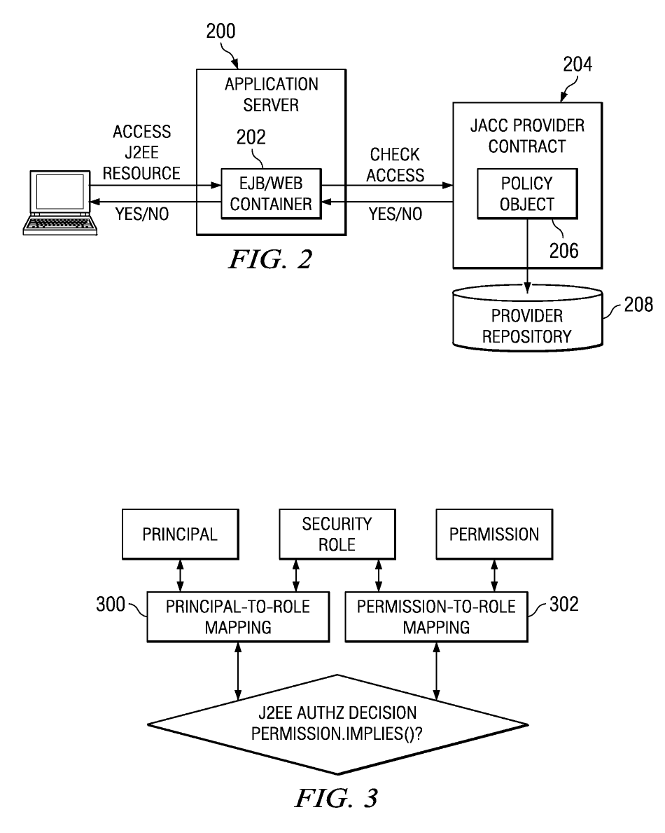

### DETAILED DESCRIPTION OF AN ILLUSTRATIVE EMBODIMENT

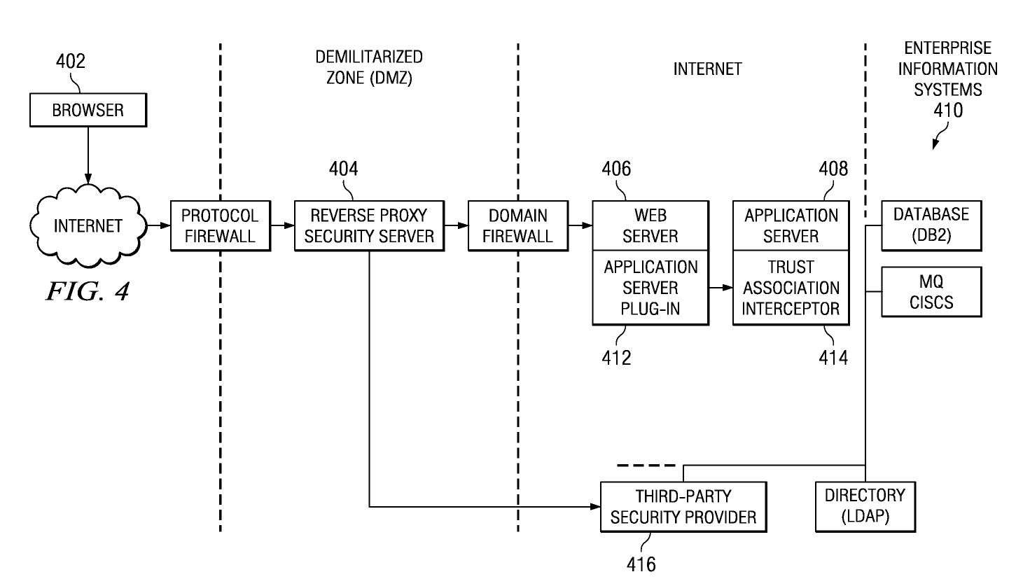

FIG. 4 is a representative enterprise environment in which an end user (such as client browser 402) requests an enterprise service or resource. The enterprise typically comprises a front end proxy server 404, a Web server 406, an application server 408, and back end information systems 410. A plug-in 412 interfaces the Web server 406 to the application server 408, which has an associated trust association interceptor 414. As an example, the application server 408 is implemented in an IBM WebSphere application server platform, and the trust association interceptor 416 is provided by IBM Tivoli Access Manager (TAM). The enterprise is associated with a third party security provider 416. As used herein, a “provider” such as security provider 416 typically is a software component that contains implementations of a policy configuration, and policy decision classes as defined by the Java specification. As described above, the application server 408 supports a J2EE application comprising one or more containers (e.g., an enterprise bean or Web resource) that may interface to the security provider 416 in accordance with the JACC Version 1.0 specification. Enforcement of either programmatic or declarative security depends upon determining if the principal associated with an incoming request of an enterprise bean or Web resource is in a given security role or not. A container makes this determination based on the security attributes of the calling principal. As used herein, a “principal” is a security attribute acquired as a result of authentication by entities that perform activities, or an entity that performs activities.

More generally, a J2EE application is any collection of J2EE modules that must share a common principal-to-role mapping. By way of additional background, it is known that during assembly of an application, permission to execute methods is granted to one or more roles. A role is a set of permissions. As used herein, a given “permission” represents a set of activities (a set of one or more operations on some set of one or more resources) that is the target of an authorization decision. Thus, for example, assume that the enterprise shown in FIG. 4 implements a banking application. In such case, the roles may include teller, supervisor, clerk, and other industry-related positions. The teller role may be associated with permissions to run methods (e.g., withdraw and deposit) related to managing funds in an account. In such case, the Teller role is not granted permission to close accounts, which, for example, is a permission given only to the Supervisor role. An application assembler defines a list of method permissions for each role. This list then is stored in a deployment descriptor for the application. During deployment of the application, real users or groups of users are assigned to the roles. The application deployer does not need to understand the individual methods. By assigning roles to methods, the application assembler simplifies the job of the application deployer; instead of working with a set of methods, the deployer works with the roles, which represent semantic groupings of the methods. When a user is assigned to a role, the user gets all the method permissions that are granted to that role. Users can be assigned to more that one role; the permissions granted to the user then are the union of the permissions granted to each role. Additionally, if an authentication mechanism supports the grouping of users, these groups can be assigned to roles. Assigning a group to a role has the same effect as assigning each individual user to the role. At execution time, the application server authorizes incoming requests based on the user's identification information and the mapping of the user to roles. In particular, if the user belongs to any role that has permission to execute a method, the request is authorized. If, however, the user does not belong to any role that has permission, the request is denied.

The J2EE approach described in the previous paragraph represents a declarative approach to authorization. For situations that cannot be dealt with declaratively, J2EE provides methods for determining user and role information programmatically. Thus, for example, for enterprise beans the following two methods are supported: getCallerPrincipal, which method retrieves the user's identification information, and isCallerInRole, which method method checks the user's identification information against a specific role. For servlets, the following methods typically are supported: getRemoteUser, isUserInRole, and getUserPrincipal. These methods correspond in purpose to the enterprise-bean methods.

The JACC specification defines three (3) primary “contract” components: a deployment tools contract, a container contract, and a provider contract. J2EE deployment tools must translate and complete the declarative policy statements appearing in deployment descriptors into a form suitable for securing applications on the platform. The resulting policy statements may differ in form from the policy statements appearing in the deployment descriptors. The JACC specification requires that the policy information in the deployment descriptor be propagated to the container during the application install time. The policy information contains the security-related information in the deployment descriptor. Specifically, security_constraint information in a web.xml file and method permission information in a ejb-jar.xml file along with security_role_ref information in both these files is propagated to the provider in a format specified by the contract. The format is different for Web and EJB modules and is governed by the rules specified in the deployment tools contract. The container contract specifies how the container creates the permission objects during access checks and calls the provider with appropriate information to help make the access decision. When a resource is being accessed, the container is expected to create the appropriate permission object and call the provider's Policy.implies method. The container is also expected to register what are called the policy context handler objects that contain additional information to make the access decision. Lastly, the provider contract specifies that each JRE (Java runtime environment) of an application server should be provided with classes that implement a PolicyConfigurationFactory class and a PolicyConfiguration interface. The classes are used by the container to propagate the security information to the provider. The provider is also expected to provide the implementation for the java.security.Policy object. This Policy object assumes responsibility for performing all access decisions within the JRE in which it is installed.

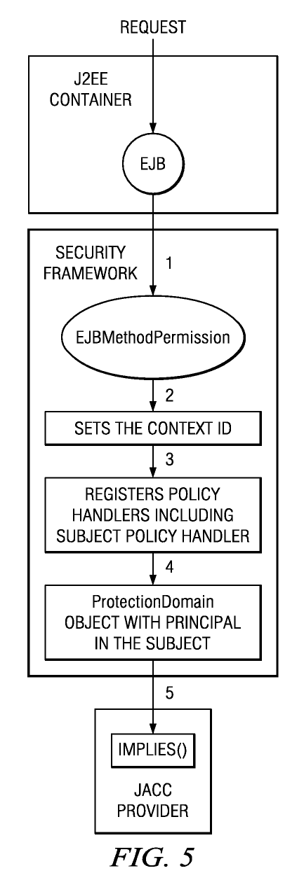

The typical use scenario is as follows. An authenticated user makes a request to an EJB or Web resource in the application server; the security runtime then makes the decision whether to allow the access or not. This is sometimes referred to herein as an access or authorization decision. FIG. 5 illustrates shows the generic flow of the access decision for an enterprise java bean (EJB) resource in a J2EE-compliant environment where external authorization is enabled through JACC. The J2EE-compliant platform is an application server executing an enterprise bean. Based on JACC, the appropriate permission object is created, the appropriate policy context handlers are registered, and the appropriate policy context identifier (contextID) is set. A call is made to the java.security.Policy object method implemented by the provider to make the access decision. FIG. 5 illustrates this process in detail. In particular, at step (1), the bean creates an EJBMethodPermission object using the bean name, method name, interface name and the method signature. At step (2), the bean creates a contextID and sets it on the thread, e.g., by using a PolicyContext.setContextID(contextID) method. At step (3), the bean registers required policy context handlers, including a Subject policy context handler. At step (4), the bean creates a ProtectionDomain object with principal in the subject. If there is no principal, null is passed for the principal name. At step (5), the access decision is delegated to the JACC provider by calling the implieso method of the Policy object, which is implemented by the provider. The EJBMethodPermission and the ProtectionDomain objects are passed to this method. The access decision is then returned to complete the process. The isCallerInRole( ) access check also follows the same process, except that an EJBRoleRefPermission object is created instead of an EJBMethodPermission. Although not shown, similar processing is carried out for the Web resource access decision. Thus, for example, if HTTP is used, a webUserDataPermission is constructed with the urlPattern accessed, along with the HTTP method invoked and the transport type of the request. The ProtectionDomain with a null principal name is created. The JACC provider's Policy.implies( ) method is called with the permission and the protection domain. If the request is using the HTTPS protocol and the implies method returns false, an HTTP 403 error is returned to imply excluded/precluded permission and no further checks are performed. If the request is not using the HTTPS protocol and the implies method returns false, the request is redirected over HTTPS.

The present invention extends the architecture described above to provide for more fine-grained policy and instance-based “Conditions” for authorization evaluation. The framework enables a provider to provide an instance-based runtime authorization decision when a caller entity requests a J2EE resource.

In particular, the invention provides for a conditional permission, which is preferably implemented as a Java ConditionalPermission class. During policy configuration, certain “Conditions” may be associated with a standard Java Permission object using the ConditionalPermission class. Each “Condition” may be represented in one of a set of different conditions (e.g., comparison, containment, logical, owner and regular expression conditions) using various name-value pairs of “AttributeName” objects. During runtime, an “implies” method in the ConditionalPermission class returns true if the argument permission is implied by the wrapped permission and the additional “Conditions” are evaluated to be true. The ConditionalPermission class allows a caller to seamlessly instrument an instance evaluation “Condition” into a regular permission evaluation and to hand off this evaluation to a JACC-compliant provider to facilitate an instance-based runtime authorization decision.

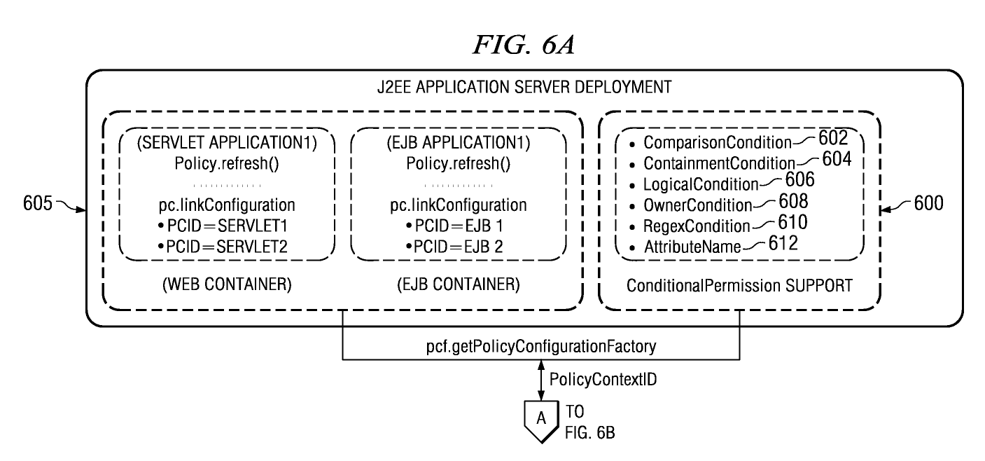

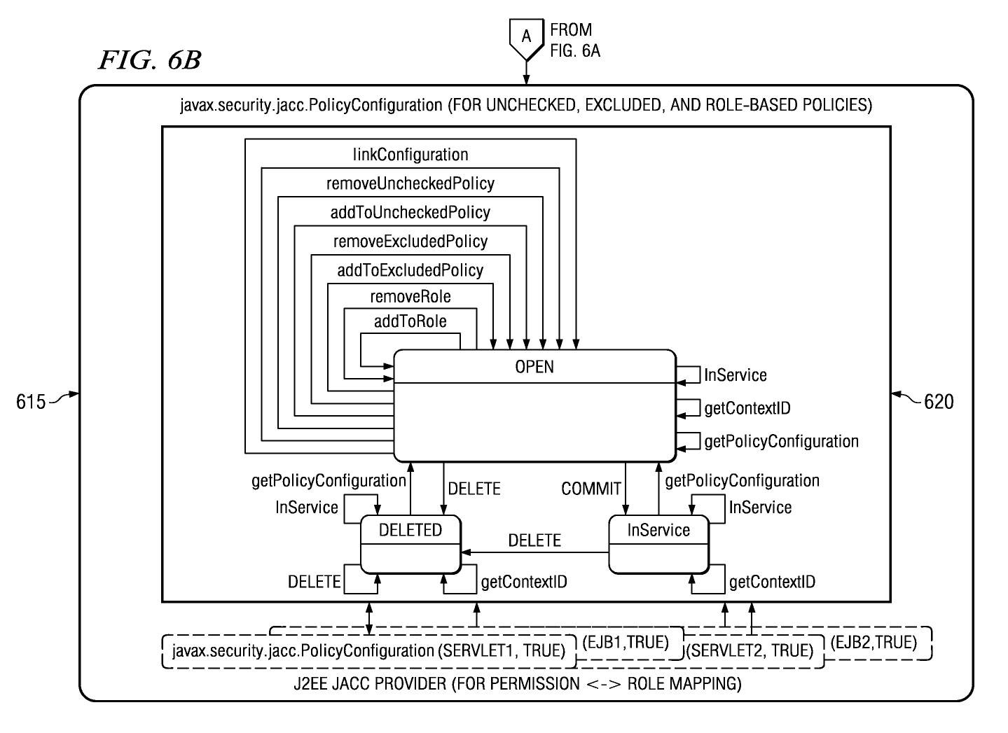

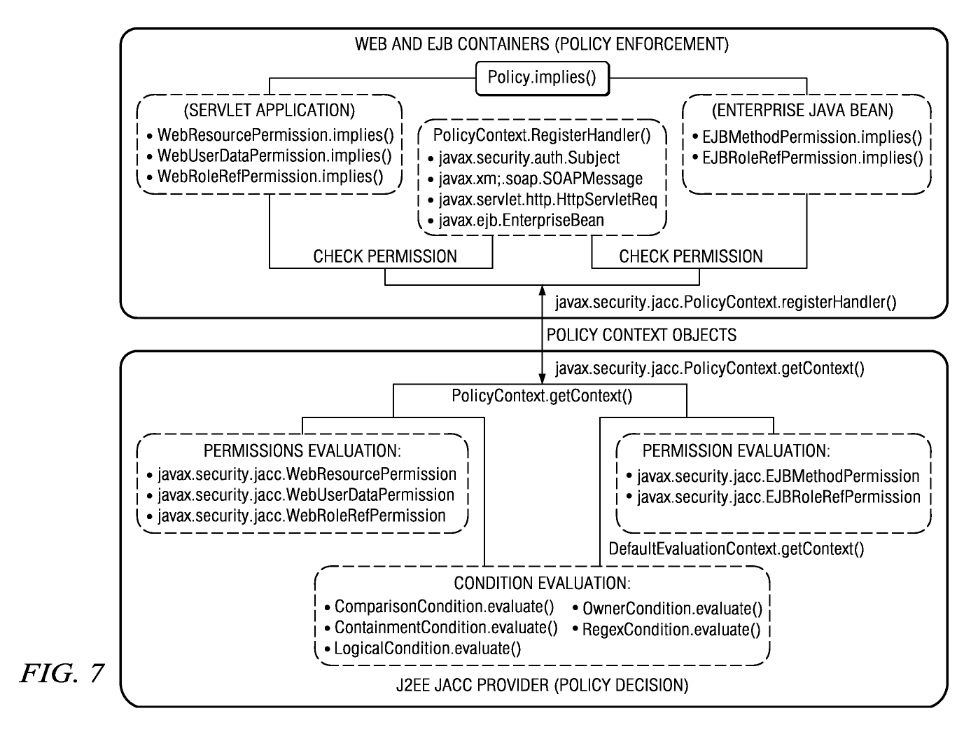

FIG. 6 illustrates a J2EE JACC conditional permission operation model of the present invention during a policy configuration phase. FIG. 7 illustrates the J2EE JACC conditional permission operation model of the present invention during a policy decision and enforcement phase.

As seen in FIG. 6, the ConditionalPermission support 600 is provided by the Java classes including the comparison condition class 602, the containment condition class 604, the logical condition class 606, the owner condition class 608, the regular expression (regex) condition class 610, and the attribute name class 612. These classes and their respective fields, methods and constructor summaries are set forth below. As can be seen in FIG. 6, the ConditionalPermission support 600 preferably comprises a subclass of the PolicyConfigurationFactory class in the J2EE-compliant application server deployment 605. As described above, that class interfaces to the JACC provider 615 through the PolicyConfiguration class to facilitate authorization decisions. The JACC provider 615 shows a depiction of a policy context life cycle 620 as affected through the methods of the PolicyConfiguration interface. As can be seen, a policy context is in one of three states (open, inService and deleted) and all implementations of the PolicyConfiguration interface implement the state semantics as described in Section 3.1.1.1 of the JACC Version 1.0 Specification.

FIG. 7 illustrates how the conditional permission is evaluated during a runtime operation to make the access decision. This was the process described generally in FIG. 5 above. As can be seen, the JACC provider 715 performs the condition evaluation using the ConditionalPermission classes 700 as described above. The particular evaluation (i.e., comparison, containment, logical, owner or regex) depends on the conditional permission specified of course. In operation, the calling object (e.g., servlet 702 or enterprise bean 704) registers the appropriate policy context handlers 706, and the appropriate policy context identifier (contextID) is set. A call is made to the java.security.Policy object method (e.g., 708 or 710) implemented by the provider to make the access decision. In this case, however, as a result of the conditional permission the decision is instance-based or more fine-grained as compared to the prior art.

This instance-based approach can be seen in the following use cases, which are merely representative.

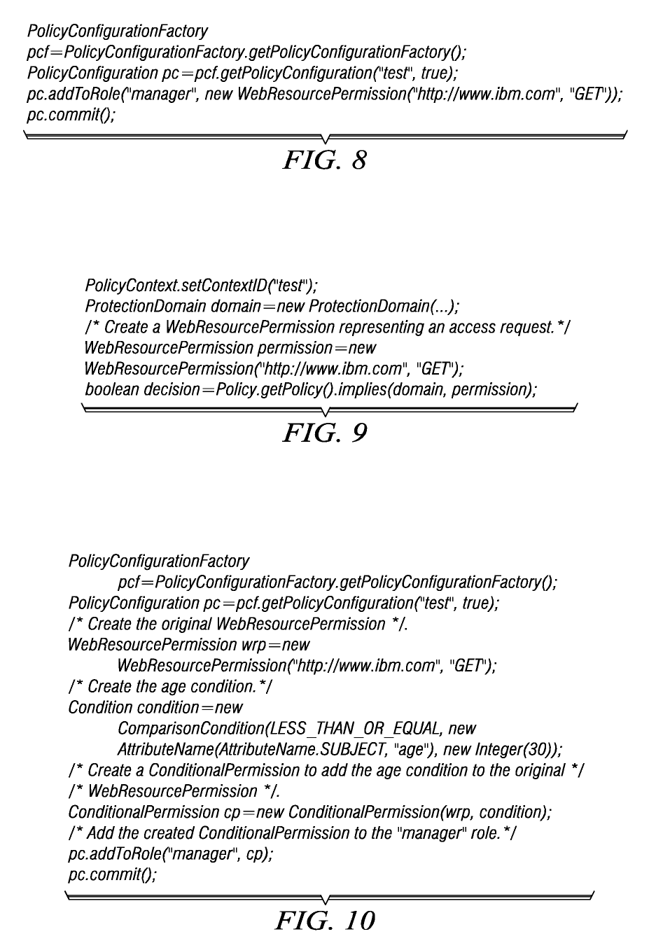

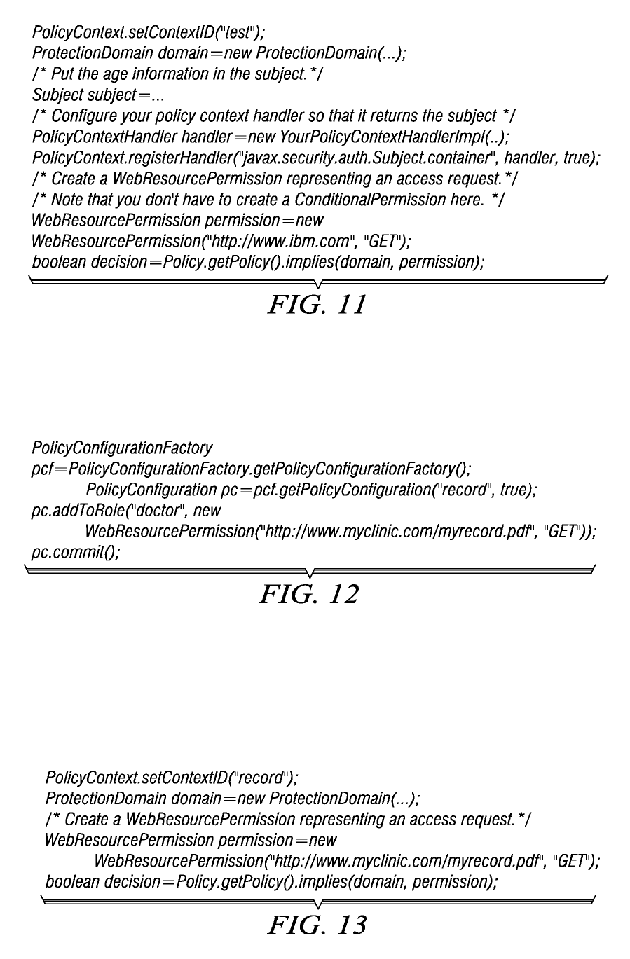

Assume a policy statement that users with the “manager” role are allowed to “GET” the URL “http://www.ibm.com.” According to the JACC Specification, this policy is configured through PolicyConfiguration.addToRole( ) as illustrated in FIG. 8. At runtime, a policy enforcement point (PEP) evaluates the configured policy statement as illustrated in FIG. 9. This is a conventional operation prior to the conditional permission support provided by the present invention. Now, assume it is desired to add an additional (fine-grained) condition to the above policy statement, e.g., a user with the “manager” role is allowed to “GET” the URL “http://www.ibm.com” if his/her age is less than or equal to 30, where it is assumed that the age information is passed to JACC provider as part of the Subject in the PolicyContext. According to the present invention, the ConditionalPermission interface (and, in particular, the comparison condition class) is used for this purpose. During the policy configuration phase, the ConditionalPermission interface is to specify the conditional policy statement, which is shown in FIG. 10. At runtime, the policy enforcement point (PEP) is responsible for providing the age information as part of Subject. The code is shown in FIG. 11. Note that the ConditionalPermission is not required to be used to represent the access request. The resulting instance-based runtime authorization decision is much more fine-grained as compared to the prior art (as evidenced by FIG. 9).

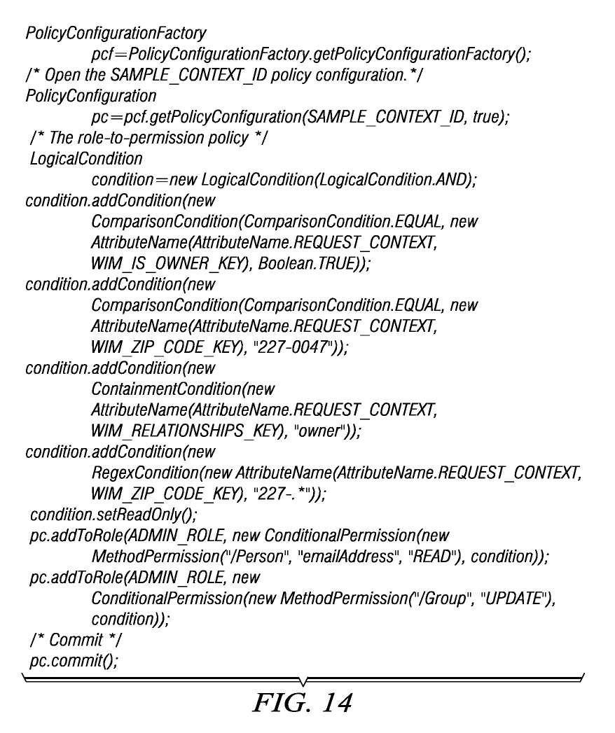

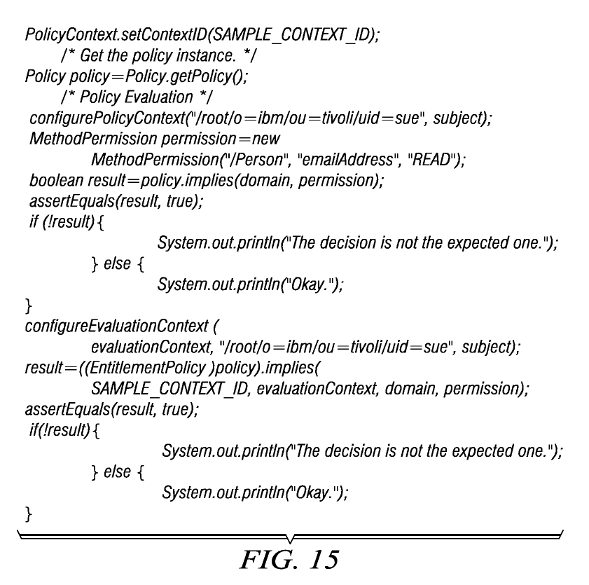

As another example, assume a policy statement that users with the “doctor” role are allowed to “GET” the URL “http://www.myclinic.com/myrecord.pdf”. In JACC, this policy statement can be configured through PolicyConfiguration.addToRole( ) method as illustrated in FIG. 12. At runtime, a policy enforcement point (PEP) evaluates the configured policy statements as shown in FIG. 13. Preferably, the WebResourcePermission is used to represent both the access control policy statement (at policy configuration time) and the access request (at runtime). Once again, this is a conventional operation without the conditional permission support. Now, assume it is desired to add an additional condition to the above policy statement, e.g., a user with the “doctor” role is allowed to “GET” the URL “http://www.myclinic.com myrecord.pdf” ifhis/her phone number is 512-451-3355, where it is assumed that the phone number information is passed to JACC provider as part of the Subject in the PolicyContext. During the policy configuration phase, the ConditionalPermission interface is to specify the new conditional policy statement, which is shown in FIG. 14. At runtime, the policy enforcement point (PEP) is responsible for providing the phone number information as part of Subject. The code is shown in FIG. 15. As described above, in this example ConditionalPermission wraps an arbitrary Permission instance to add the additional fine-grained condition. The implies method then returns true if the argument permission is implied by the wrapped permission and the additional condition is satisfied.

The following describes a preferred set of interfaces that are used to extend the JACC specification to provide for conditional permissions according to the present invention.

### Class AttributeName

This class represents an attribute name, which can be used to identify an attribute in Subject, ResourceContext, and RequestContext. An attribute name comprises a source identifier and an attribute name. The source identifier must be one of SUBJECT, REQUEST_CONTEAT, and RESOURCE_CONTEXT. For example, if the source identifier is SUBJECT, this attribute name identifies the corresponding attribute retrieved from a Subject. These contexts are put in EvaluationContext at evaluation time.

### Field Summary

static int REOUEST CONTEXT—The source identifier representing javax.securityjacc.PolicyContext and EvaluationContext.
static int RESOURCE CONTEXT—The source identifier representing ResourceContext.
static int SUBJECT—The source identifier representing Subject.

### Method Summary

boolean equals(java.lang.Object obj)
java.lang.Object getAttribute(EvaluationContext evaluationContext)—Given an evaluation context, return the attribute value corresponding to this attribute name.
java.lang.String getAttributeName( )—Get the attribute name.
int getSource( )
int hashCode.( )
java.lang.String toStrin( )

### Interface Condition

The interface is to a condition on an evaluation context.

### Method Summary

boolean equals(java.lang.Object obj)
boolean evaluate(EvaluationContext evaluationContext)—Return the set of keys that this evaluation context can handle.
java.util.Set getReferencedAttributeNames( )—Get the set of attribute names (AttributeName) referenced in this condition.
int hashCode( )

### Class ComparisonCondition

This class represents a comparison condition that can be used to compare an attribute value with a constant value, or to compare two attribute values.

### Field Summary

static int EQUAL
static int GREATER THAN
static int GREATER THAN OR EQUAL
static int LESS THAN
static int LESS THAN OR EQUAL

### Constructor Summary

Comparison Condition to operator, AttributeName[ ] attributeNames) - Constructor for a condition to compare two attribute values.
Comparison Condition(int operator, AttributeName attributeName, java.lang.Object value)—Constructor for a condition to compare an attribute value with a constant value.

### Method Summary

boolean equals(java.lang.Object obj)
boolean evaluate(EvaluationContext evaluationContext)—Return true if the attribute value identified by the attribute name matches either the constant value or the attribute value identified by another attribute name according to the operator.
AttributeName getAnotherAttributeName( )
AttributeName getAttributeName( )
int getOperator( )
int getSource( )
java.util.Set getReferencedAttributeNames( )—Get the set of attribute names (AttributeName) referenced in this condition.
java.lang.Object getValue( )
int hashCode.( )

### Class ConditionalPermission

A conditional permission. ConditionalPermission wraps a Permission instance to add some additional conditions to it. The getName and getActions methods return the values corresponding to the wrapped permission. The implies method returns true if and only if the argument permission is implied by the wrapped permission and the additional conditions are evaluated to be true. The newPermissionCollection method is not implemented.

### Field Summary

static int condition—The additional condition.
static int permission—The wrapped permission.

### Constructor Summary

ConditionalPermission(java.security.Permission permission, Condition condition)—Construct a ConditionalPermission instance with a permission to be wrapped and a condition.

### Method Summary

boolean equals(java.lang.Object obj)
java.lang.String getActions( )
Condition getCondition( )—Get the additional condition.
java.util.Set getReferencedAttributeNames( )
java.security.Permission getWrappedPermission( )—Get the wrapped condition.
int hashCode( )
boolean implies(java.security.Permission permission)—Given a permission, return true iff the permission is implied by the wrapped permission and the additional condition is evaluated to be true on the policy context associated with the current thread.
boolean implies(java.security.Permission permission, EvaluationContext evaluationContext)—Given a permission and an evaluation context, return true if and only if the argument permission is implied by the wrapped permission and the additional condition is evaluated to be true on the evaluation context.
java.security.PermissionCollection newPermissionCollection( )—Return an empty ConditionalPermissionCollectioninstance.

### Class ConditionalPermission Collection

This is the permission collection class for ConditionalPermission.

### Constructor Summary

ConditionalPermissionCollection( )—Constructor.

### Method Summary

abstract boolean implies(java.security.Permission permission, EvaluationContext evaluationContext)—Given a permission and an evaluation context, return true if and only if the argument permission is implied by this collection under the evaluation context.

### Class ContainmentCondition

This class represents a containment test, i.e., checks whether an attribute value (a Set object) contains a constant value.

### Constructor Summary

ContainmentCondition(AttributeName attributeName, java.lang.Object value)—Constructor.

### Method Summary

boolean equals(java.lang.Object obj)
boolean evaluate(EvaluationContext evaluationContext)—Return true if and only if the attribute value (a Set object) identified by the attribute name contains the constant value.
AttributeName getAttributeName( )
java.util.Set getReferencedAttributeNames( )—Get the set of attribute names (AttributeName) referenced in this condition.
java.lang.Object getValue( )
int hashCode.( )

### Class LogicalCondition

This class represents the logical “AND” or “OR” of multiple Condition objects. Also, it represents the “NOT” (negation) of a Condition object.

### Field Summary

static int AND
static int NOT
static int OR

### Constructor Summary

LogicalCondition(int logic)—Constructor.
LogicalCondition(int logic, java.util.Set conditions)—Construct a read-only instance from a logic operator and a set of conditions.

### Method Summary

void addCondition(Condition condition)—Add a condition to this logical condition.
boolean equals(java.lang.Object obj)
boolean evaluate(EvaluationContext evaluationContext)—Return true if and only if the conditions are satisfied according to the logic operator.
java.util.Set getConditions( )—Return the conditions to be combined by the logic operator.
int getLoic( )—Return the logic operator.
java.util.Set getReferencedAttributeNames( )—Get the set of attribute names (AttributeName) referenced in this condition.
int hashCode.( )
boolean isReadonOnly( )—Check whether this logical condition is read-only.
void setReadonOnly( )—Mark this LogicalCondition object as “read-only”.

### Class OwnerCondition

This class represents the owner condition that, given an evaluation context, checks whether or not the subject is the owner of the resource under the evaluation context. This class has the private constructor and defines the static singleton instance OWNER_CONDITION. To use this singleton instance, the resource context attribute ResourceContext.IS_OWNER must be provided by callers.

### Field Summary

static OwnerCondition OWNER CONDITION—The singleton instance for the owner condition.

### Method Summary

boolean equals(java.lang.Object obj)
boolean evaluate(EvaluationContext evaluationContext)—Return true if and only if the user principal or subject is the owner of the resource to be accessed.
java.util.Set getReferencedAttributeNames( )—Get the set of attribute names (AttributeName) referenced in this condition.
int hashCode.( )

### Class RegexCondition

This class represents a regular expression matching, i.e., checks whether an attribute value matches a regular expression.

### Constructor Summary

RegexCondition(AttributeName attributeName, java.lang.String regex)—Constructor.

### Method Summary

boolean equals(java.lang.Object obj)
boolean evaluate(EvaluationContext evaluationContext)—Return true if and only if the attribute value (a String object) identified by the attribute name matches the regular expression.
AttributeName getAttributeName( )
java.util.Set getReferencedAttributeNames( )—Get the set of attribute names (AttributeName) referenced in this condition.
java.lang.String getRegex( )
int hashCode.( )

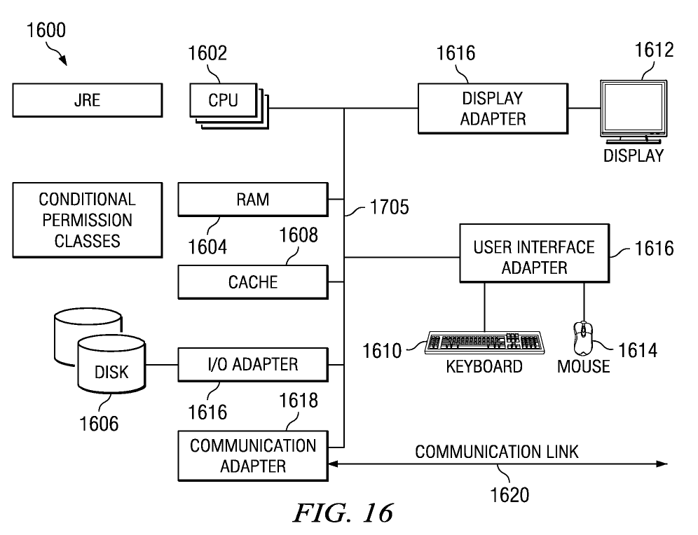

FIG. 16 illustrates a representative data processing system 1600 for use as the J2EE-compliant platform or the JACC-compliant provider platform. A data processing system 1600 suitable for storing and/or executing program code will include at least one processor 1602 coupled directly or indirectly to memory elements through a system bus 1605. The memory elements can include local memory 1604 employed during actual execution of the program code, bulk storage 1606, and cache memories 1608 that provide temporary storage of at least some program code to reduce the number of times code must be retrieved from bulk storage during execution. Input/output or I/O devices (including but not limited to keyboards 1610, displays 1612, pointing devices 1614, etc.) can be coupled to the system either directly or through intervening I/O controllers 1616. Network adapters 1618 may also be coupled to the system to enable the data processing system to become coupled to other data processing systems or devices through intervening private or public networks 1620. For Java, the system comprises a Java Runtime Environment (JRE) and a set of one or more containers (either a J2EE container or a Java runtime that manages objects) for providing Web tier and/or enterprise tier support, as well as support for the Java classes referenced above, including the conditional permission support classes. For JACC, the system comprises the policy configuration support, as well as the policy decision classes defined by the Java specification. The JACC also includes the evaluation components of the conditional permission support classes.

The invention can take the form of an entirely hardware embodiment, an entirely software embodiment or an embodiment containing both hardware and software elements. In a preferred embodiment, the inventive transform is implemented in software, which includes but is not limited to firmware, resident software, microcode, and the like. Furthermore, as noted above, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

Having described our invention, what we now claim is as follows.

1. A method of access control, comprising:
configuring a security policy having a permission to include a condition;
responsive to a request to access a resource, evaluating the configured policy; and
authorizing access to the resource if the condition is satisfied.

2. The method as described in claim 1 wherein the resource is one of: a Java resource, and a resource accessible from a Java environment.

3. The method as described in claim 1 wherein the condition is a comparison condition.

4. The method as described in claim 1 wherein the condition is a containment condition.

5. The method as described in claim 1 wherein the condition is a logical condition.

6. The method as described in claim 1 wherein the condition is an owner condition.

7. The method as described in claim 1 wherein the condition is a regular expression condition.

8. The method as described in claim 1 wherein the configured policy is evaluated by a provider external to the resource.

9. The method as described in claim 1 wherein the resource is a Java resource and the configured policy is evaluated by a JACC-compliant provider.

10. A method of access control, comprising:
wrapping a role-based permission in a conditional permission class, the conditional permission class having a condition associated with the role-based permission;
upon a given occurrence, determining if the conditional permission is implied by the role-based permission and the condition is satisfied;
if the conditional permission is implied by the role-based permission and the condition is satisfied, authorizing access to a resource.

11. The method as described in claim 1 wherein the resource is a Java-based resource implemented in a Java class that is one of: a J2EE-compliant Web tier resource and a J2EE-compliant enterprise tier resource.

12. The method as described in claim 11 wherein the J2EE-compliant Web tier resource is one of: a servlet, a JSP page, and a Java bean.

13. The method as described in claim 11 wherein the J2EE-compliant enterprise tier resource is one of: a session bean, and an enterprise bean.

14. The method as described in claim 11 wherein the condition is any condition implemented in Java and includes one of: a comparison condition, a containment condition, a logical condition, an owner condition, a business rule, and a regular expression condition.

15. The method as described in claim 14 wherein a given one of the conditions is evaluated against a given attribute.

16. In an enterprise computing environment comprising a Java runtime and a JACC-compliant provider, the improvement comprising:
a set of classes comprising a conditional permission class, and a set of one or more condition classes;
wherein the conditional permission class and at least one of the condition classes are configurable to specify a condition associated with a role-based permission; and
wherein, in response to a request to access a resource associated with the Java runtime, the JACC-compliant provider evaluates the conditional permission class and provides access to the resource if the condition is met.

17. The enterprise computing environment as described in claim 16 further including an attribute name class.

18. The enterprise computing environment as described in claim 16 further including a conditional permission collection class.

19. The enterprise computing environment as described in claim 16 wherein the condition is one of: a comparison condition, a containment condition, a logical condition, an owner condition, and a regular expression condition.

20. A system, comprising:
a policy configuration class executable by a first processor to create a security policy that includes a permission configured to include a condition; and
a policy enforcement class executable by a second processor to evaluate the security policy and return an authorization if the condition is satisfied.

21. A server comprising a processor, and a computer-readable medium, the computer-readable medium having processor-executable instructions for performing the method steps of claim 1.

22. A computer-readable medium having computer-executable instructions for performing the method steps of claim 1.
